(19) United States
(12) Patent Application Publication
(10) Pub. No.: US 2025/0208573 A1
(43) Pub. Date: Jun. 26, 2025

(54) BALANCE SPRING FOR A HOROLOGICAL REGULATING MEMBER PROVIDED WITH TEMPERATURE-DEPENDENT ADJUSTMENT MEANS

(71) Applicant: Nivarox-FAR S.A., Le Locle (CH)

(72) Inventor: Geoffrey CHASSIN, Morteau (FR)

(73) Assignee: Nivarox-FAR S.A., Le Locle (CH)

(21) Appl. No.: 18/926,557

(22) Filed: Oct. 25, 2024

(30) Foreign Application Priority Data
Dec. 21, 2023 (EP) 23219393.8

(51) Int. Cl. G04B 17/22; G04B 17/06; G04B 17/34

(52) U.S. Cl. CPC G04B 17/222; G04B 17/063; G04B 17/345

(57) ABSTRACT

A balance spring, in particular for a horological regulating member, the balance spring (100) including a flexible strip (2) wound about itself in several turns, the strip (2) having a predefined stiffness, the balance spring (100) having a stiffener for adjusting its stiffness, the balance spring (1) also including an actuator (10) for actuating the adjustment means, depending on the ambient temperature. Also, a horological regulating member including such a balance spring.

### CROSS-REFERENCE TO RELATED APPLICATIONS

This application claims priority to European Patent Application No. 23219393.8 filed Dec. 21, 2023, the entire contents of which are incorporated herein by reference.

### TECHNICAL FIELD OF THE INVENTION

The invention relates to a balance spring for a horological regulating member, the balance spring being provided with temperature-dependent adjustment means. The invention further relates to a horological regulating member provided with such a balance spring.

### TECHNOLOGICAL BACKGROUND

In most mechanical watches, the energy required to rotate the hands (for example the minute and hour hands) is stored in a barrel and then delivered by a sprung balance system, which comprises a flywheel called a balance, combined with a spring in the form of a spirally wound strip called a balance spring.

An inside end of the balance spring is attached to a staff that rotates as one with the balance; an outside end of the balance spring is attached to a stud mounted on a stud-holder that is itself rigidly connected to a stationary cock.

The rotation of the balance is maintained—and its oscillations counted—by an escapement mechanism comprising a pallet-lever animated by a low-amplitude oscillating motion, provided with two pallets which engage the teeth of an escape wheel. When the escape wheel is engaged in this way, it is caused to rotate in steps, the frequency of which rotation is determined by the frequency of oscillation of the pallet-lever, which is itself set to the frequency of oscillation of the sprung balance.

In a conventional escapement mechanism, the oscillation frequency is around 4 Hz, or approximately 28,800 vibrations per hour (V/h). One of the objectives of good watchmakers is to ensure the isochronism and regularity of the oscillations (or constancy of rate) of the balance.

The rate of the balance can be regulated in a known manner by adjusting the active length of the balance spring, defined as the curvilinear length between its inside end and a counting point, located in the vicinity of the outside end of the balance spring and typically defined by a pair of stops carried by a key mounted on an index system.

In operation, this index system is not able to rotate about the axis of the balance spring. However, its angular position can be fine-tuned by manual intervention, for example by pivoting an eccentric acting like a cam on the index system using a screwdriver.

The assembly comprising the cock, the index system, the key, the stud-holder, the stud, the staff, the spring and the balance is commonly referred to as the “regulating member”. Examples of regulating members are given in the international patent WO 2016/192957 and in the European patent EP 2 876 504, both filed by the watch manufacturer ETA.

There are index systems which have a stud-holder to which one end of the balance spring is attached, and where the index system key leaves play to allow the balance spring to move between the two stops. However, the chronometric properties, in particular the anisochronism as a function of amplitude, are very sensitive to play at the index key, and this play is difficult to control precisely.

In some devices, the stops can be adjusted to clamp the balance spring in order to eliminate play, particularly when the balance spring is in operation. In this case, first the rate is regulated by moving the index key, then clamping the balance spring to the key. However, clamping the balance spring to the index key risks stressing it and creating chronometric errors, in particular due to the off-centring of the windings. Moreover, removing the play also changes the rate, and once the balance spring has been clamped, you can no longer move the index key along the balance spring to finish fine-tuning the rate.

Other balance springs have an integrated regulating device. In these balance springs, the rate is not regulated by altering the effective length of the balance spring, but by applying a force or torque to a resilient element arranged in series with the balance spring. More specifically, a flexible element is placed in series with the strip between one end of the strip and a fixed support in order to modify the stiffness of the attachment point and make the resonator more flexible. Thus, the effective stiffness of the resonator includes the stiffness of the strip and the stiffness of the flexible element.

A variable force or torque is then applied to prestress the flexible element. By prestressing the flexible element, its stiffness, from which the return force acting on the balance partly results, changes, whereas the stiffness of the strip remains unchanged. By modifying the stiffness of the flexible element, the stiffness of the entire resonator (stiffness of the strip and stiffness of the flexible element) changes, which, as a result, modifies the rate of the resonator and allows the frequency of the time base to be precisely adjusted. This gives a high degree of precision when regulating the rate, as only one element is used to adjust the stiffness.

Such a balance spring provided with a resilient element is described, for example, in the patent application EP4009115 filed by Omega SA.

However, the ambient temperature has a significant impact on the rate of a regulating member comprising such a balance spring and a flywheel. This is because the balance and/or the balance spring expand or contract depending on the ambient temperature. These dimensional variations lead to variations in the rate of the regulating member.

Moreover, the resilient constants also change depending on the ambient temperature, thus modifying the stiffness of the balance spring.

To reduce these variations, regulating members have been developed that are configured to compensate for the effect of temperature. For example, when using a bimetallic balance, or in the case of balance springs made from silicon, a layer of silicon oxide is added, which has a thermoelastic coefficient opposite to that of the silicon from which the balance spring is made (see patent EP1422436).

However, these configurations are only effective around a predefined specific temperature, and they are no longer sufficiently effective when the temperature deviates from this specific temperature.

### SUMMARY OF THE INVENTION

The aim of the present invention is to overcome some or all of the aforementioned drawbacks, in particular to minimise the sensitivity of the regulating member to changes in ambient temperature, by providing a balance spring provided with effective adjustment means which adapt to the ambient temperature, even when temperature variations are significant.

To this end, the invention relates to a balance spring for a horological regulating member, the balance spring comprising a flexible strip wound about itself in several turns, the strip having a predefined stiffness, the balance spring comprising means for adjusting its stiffness, the balance spring comprising actuation means for actuating the adjustment means.

The invention is characterised in that the actuation means actuate the adjustment means depending on the ambient temperature.

Thanks to the actuation means, variations in the dimensions of the balance spring and/or of the balance, and thermoelastic variations in the balance spring due to temperature are compensated for, in particular in order to compensate for the quadratic effect of temperature on the rate of the regulating member. Thus, variations in the rate of the regulating member comprising said balance spring and a flywheel, and resulting from temperature variations are prevented.

According to a particular embodiment of the invention, the actuation means comprise a temperature-dependent deformable element.

According to a particular embodiment of the invention, the deformable element comprises a temperature-sensitive material.

According to a particular embodiment of the invention, the deformable element is a bimetallic attachment.

According to a particular embodiment of the invention, the deformable element comprises a microstructure, or even a nanostructure.

According to a particular embodiment of the invention, the actuation means comprise a support body that can be moved by the deformable element, which moves it according to its deformation into a plurality of positions.

According to a particular embodiment of the invention, the adjustment means comprise a flexible element arranged in series with the strip, the flexible element connecting one end of said strip to a fixed support, so as to add additional stiffness following the strip, the flexible element preferably having a stiffness greater than that of the strip.

According to a particular embodiment of the invention, the adjustment means comprise prestressing means for applying a variable force or torque to the flexible element, so as to vary the stiffness of the flexible element.

According to a particular embodiment of the invention, the support body is in contact with the prestressing means.

According to a particular embodiment of the invention, the support body comprises a rod with a first end mounted on the deformable element and a second end mounted on the prestressing means.

According to a particular embodiment of the invention, the actuation means comprise a fixed pin, which allows the rod to form a lever.

According to a particular embodiment of the invention, the flexible element comprises two flexible parts, each of which connects the strip to the fixed support, the two flexible parts being arranged axially symmetrically relative to one another along an axis, the axis preferably passing substantially through the centre of the balance spring.

According to a particular embodiment of the invention, the prestressing means comprise two flexible levers each connected to a flexible part.

According to a particular embodiment of the invention, the two levers are connected to each other by a movable body.

The invention further relates to a regulating member, in particular for a horological movement, comprising an oscillating weight and such a balance spring.

### BRIEF DESCRIPTION OF THE FIGURES

The purposes, advantages and features of the present invention will become apparent after reading several embodiments, which are provided for purposes of illustration only and not intended to limit the scope of the invention, given with reference to the accompanying drawings, wherein:

FIG. 1 diagrammatically shows a top view of a balance spring according to a first embodiment of the invention, with the balance spring being in a first configuration,

FIG. 2 diagrammatically shows a top view of the balance spring shown in FIG. 1 in a second configuration,

FIG. 3 diagrammatically shows a top view of the balance spring shown in FIG. 1 in a third configuration,

FIG. 4 is a graph showing the effect of the adjustment means on the temperature variation,

FIG. 5 diagrammatically shows a top view of a balance spring according to a second embodiment of the invention, and

FIG. 6 diagrammatically shows a top view of a balance spring according to a third embodiment of the invention.

### DETAILED DESCRIPTION OF THE INVENTION

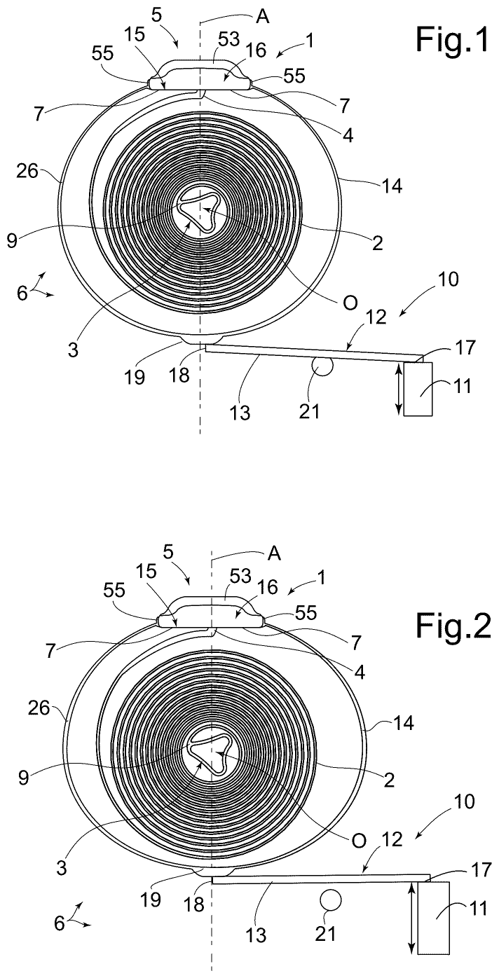

FIGS. 1 to 3 each diagrammatically show a first embodiment of a balance spring 1, in particular for a horological regulating member. The three figures show three different configurations of the balance spring 1.

In this case, the balance spring 1 extends substantially in one plane. The balance spring 1 comprises a flexible strip 2 wound about itself in several turns, the strip 2 having a predefined stiffness.

The balance spring comprises means for adjusting its stiffness. For example, the adjustment means can be actuated in particular when the balance spring is mounted in a regulating member, in particular assembled on a plate of a horological movement.

The adjustment means comprise a flexible element 5 arranged in series with the strip 2, with the flexible element 5 connecting an outside end 4 of said strip 2 to a fixed support 53, and integral with the outside end 4 of the strip 2. The flexible element 5 adds additional stiffness to that of the strip 2. The flexible element 5 is preferably stiffer than the strip 2. The flexible element 5 is arranged following the strip 2, in the continuation thereof. Preferably, the adjustment means 5 and the strip 2 are in one piece, or even made of the same material. The balance spring 1 further includes prestressing means 6 for applying a variable force or torque to the flexible element 5. The stiffness of the balance spring 1 can thus be adjusted, in particular to improve the precision of the movement's rate.

In this embodiment of the balance spring, the flexible element 5 comprises two flexible parts 15, 16, each connecting the strip 2 to a fixed support 53.

The two flexible parts 15, 16 are arranged, relative to one another, in axial symmetry along an axis A of the balance spring 1. In other words, the two flexible parts 15, 16 are positioned so as to be symmetrical relative to said axis A.

On the one hand, the axis A passes substantially through the centre O of the balance spring, and on the other hand, the axis A preferably passes through the outside end 4 of the strip 2.

Thus, the two flexible parts 15, 16 are arranged on the periphery of the balance spring, such that the two flexible parts 15, 16 are arranged at the same distance from the centre O of the balance spring 1.

The two flexible parts 15, 16 are preferably arranged relative to one another in a “mirror-like” position relative to the axis A. To this end, the two flexible parts 15, 16 are preferably substantially identical.

The flexible parts 15, 16 each comprise a curved flexible blade 55, preferably forming a semi-circle, and extending from the end of the fixed support 53. Each curved flexible blade 55 is also connected to the outside end 4 of the strip 2 by a main flexible blade 7. In this case, the main flexible blades 7 are arranged in the continuation of one another.

The curved blade 55 forms a semi-circular curve, which is extended by the single flexible blade 7 at one end and by the fixed support 53 at the other. The end 56 of the support itself forms a curve with a counter-curvature opposite that of the curved blade 55. The end 56 of the support 53 is semi-rigid so that it can be partially deformed.

This arrangement of curvature and counter-curvature makes it possible to prevent modifying the isochronism of the regulating member when the rate is modified using the adjustment means. More specifically, the force exerted on the top of the curved blade 55 is compensated for by the reaction force of the counter-curvature of the end 56, as shown by the arrows in FIG. 14. Thus, only the single flexible blade 7 is subjected to the force or torque applied by the prestressing means 6.

The fixed support 53 has an open trapezoidal shape on the long side towards the outside end 4 of the strip 2.

The means for adjusting the balance spring 1 further include prestressing means 6 for applying a variable force or torque to the flexible element 5. In this way, the stiffness of the balance spring 1 can be adjusted. The torque or force is continuously adjustable thanks to the prestressing means 6. In other words, the torque or force is not restricted to isolated values. The stiffness of the flexible element 5 can thus be adjusted with great precision.

Preferably, the prestressing means 6 apply a substantially identical force or torque to each flexible part 15, 16, from a single force F applied to the third body 19, via the two levers 14, 26. The directions of the forces are preferably substantially symmetrical relative to the axis A.

The prestressing means 6 further comprise two levers 14, 26, each connecting a curved blade 55 to the same, preferably rigid, movable body 19 arranged on the other side of the balance spring 1 relative to the fixed support 53. The movable body 19 in this case is in the shape of an arc of a circle.

The variable force or torque is applied to the movable body 19. The variable force or torque is at least partly transmitted to the main flexible blades 7 of the flexible parts 15, 16 of the flexible element 5, via the levers 14, 26.

Preferably, the torque or force is continuously adjustable thanks to the prestressing means 6. In other words, the torque or force is not restricted to isolated values. The stiffness of the flexible element 5 can thus be adjusted with great precision.

The balance spring 1 further includes actuation means 10 for actuating the prestressing means 6.

According to the invention, the actuation means 10 actuate the prestressing means 6 depending on the ambient temperature. Thus, the actuation means 10 make it possible to compensate for the effect of temperature variations on the regulating member, by acting on the balance spring 1, modifying the stiffness in order to maintain the regulating member at a constant rate.

To this end, the actuation means 10 comprise an element 11 which can be deformed depending on the temperature. The deformable element 11 has the advantage of deforming according to temperature in a controlled manner.

In an alternative embodiment, the deformable element 11 comprises, for example, a deformable liquid or semi-liquid element, which is used, for example, in a thermometer, such as mercury or alcohol. This liquid or semi-liquid element is contained in an enclosure provided with a movable wall, which moves according to the deformation of the liquid or semi-liquid element as a function of temperature.

Alternatively, the deformable element 11 is a highly temperature-sensitive metal.

The actuation means 10 further comprise a support body 12 in contact with the prestressing means 6, in this case the movable body 19. The support body 12 is also in contact with the deformable element 11. The support body 12 is thus movable by means of the deformable element.

For example, in the case of a liquid or semi-liquid as the deformable element, the support body 12 is in contact with the movable wall, which moves the support body 12 depending on the deformation of the deformable element 11.

In the case of a metal material, the support body 12 is in direct contact therewith.

In the figures, the support body 12 comprises a rod 13 forming a lever against the prestressing means 6. The rod 13 comprises two ends 17, 18, a first end 17 being mounted on the deformable element 11, and a second end 18 being mounted against the prestressing means 6.

The actuation means 10 further comprise a pin 21, intended to remain stationary relative to the rest of the regulating member, and with which the rod 13 can be brought into contact. The pin 21 acts as a bearing point to allow the rod to form a lever. The pin 21 also forms a reference point for the rate of the regulating member.

The pin 21, for example, is positioned substantially in the middle of the rod 13. Thus, when the rod 13 is in contact with the pin 21, it bears against the pin 21 to transmit a force provided by the deformation of the deformable element 11.

Preferably, the pin 21 has a non-circular cross-section for adjusting the actuation of the deformable element 11.

In FIG. 1, the rod 13 is in contact with the movable body 19 of the prestressing means 6, and rests against the pin 21. The rod 13 exerts a force on the movable body 19 to obtain a predetermined stiffness of the balance spring 1. For example, a predetermined stiffness is chosen for an ambient temperature of 20 degrees.

In an alternative embodiment, the pin 21 is offset from the centre of the rod 13, in order to have a greater lever arm when the rod 13 is actuated.

In the configuration shown in FIG. 2, the deformable element 11 has expanded as a result of a higher temperature. The deformable element 11 pushes back the rod 13, which is no longer in contact with the pin 21. The force exerted on the moving body 19 is increased, causing the stiffness of the flexible element 5 to change.

Thus, the effect of the increase in temperature on the regulating member is compensated for by the increase in the force exerted on the prestressing means 6.

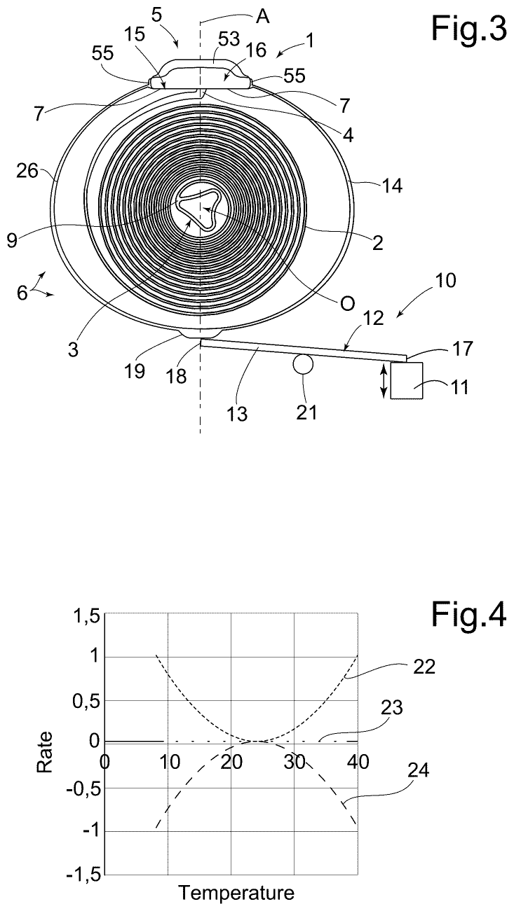

In the configuration shown in FIG. 3, the ambient temperature has fallen, causing the deformable element to contract. As a result, not only is the rod 13 brought back against the pin 21, but it also pushes back the movable body 19 due to the leverage effect. More specifically, the rod presses on the pin 21, so that the second end pushes the movable body 19 of the prestressing means 6.

As a result, the stiffness of the flexible element 5 is modified to compensate for the effect of the drop in ambient temperature on the regulating member.

In both cases, whether the ambient temperature is falling or rising, the actuation means 10 push the movable body 19 to modify the stiffness of the flexible element 5.

In FIG. 4, the graph shows three superimposed curves 22, 23, 24 showing the effect of temperature on the rate of a regulating member.

The bottom curve 24 describes the variation in rate as a function of temperature, when there is no compensation according to the invention. Thus, when the temperature increases or decreases, the difference in rate compared to the rate at 23° C. decreases. Such a curve can be achieved with the balance springs mentioned in patent EP1605182.

The top curve 22 describes the variation in rate obtained by the actuation means 10 according to the invention.

The middle curve 23 represents the effect obtained on the rate of the regulating member by the actuation means 10 according to the invention when the ambient temperature varies. The rate remains substantially constant, even though the temperature varies greatly.

More specifically, thanks to the actuation means 10, the effect of the actuation means 10, shown on the top curve 22, compensates for the effect of the temperature variation shown on the bottom curve 24, causing the rate to remain substantially constant despite the temperature difference.

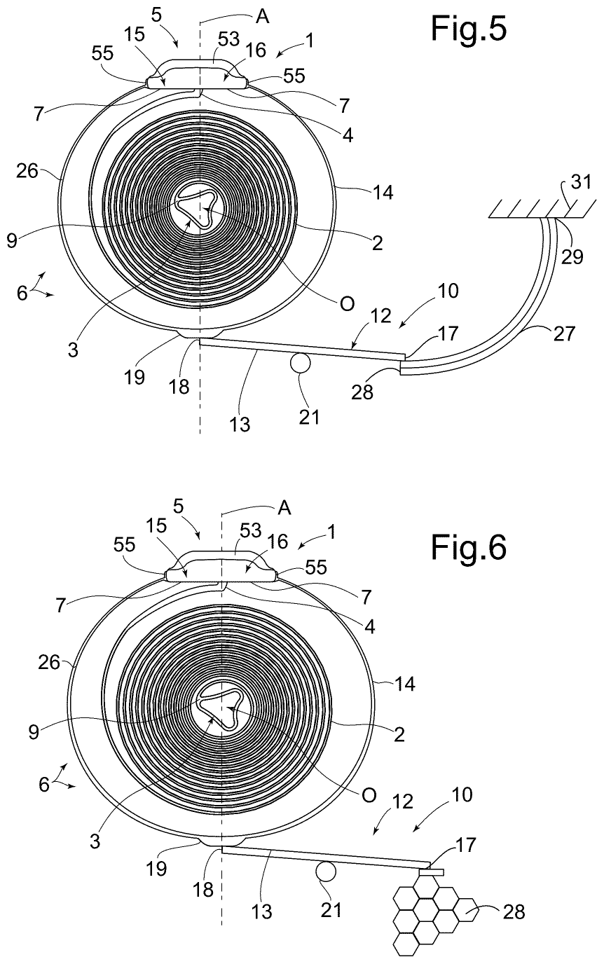

A second embodiment of the balance spring 1 is shown in FIG. 5, wherein the balance spring 1 is substantially identical to the first embodiment, except for the deformable element 27 of the adjustment means 10. In this case, the deformable element 27 comprises a bimetallic attachment which deforms depending on the temperature.

The bimetallic attachment is curved and comprises a first end 29 assembled to a fixed support 31 external to the balance spring 1. A second end 28 of the bimetallic attachment is associated with the first end 17 of the rod 12. The second end 28 of the bimetallic attachment is in contact with the first end 17 of the rod 12.

As the ambient temperature changes, the bimetallic attachment bends to a greater or lesser extent. Thus, the second end 28 of the bimetallic attachment pulls or pushes the first end 17 of the rod 12, which activates the prestressing means 6.

As a result, depending on the curvature of the bimetallic attachment, the rod 13 is moved in a similar way to that of the first embodiment.

Such a bimetallic attachment is well known to a person skilled in the art.

In the third embodiment shown in FIG. 6, the deformable element 28 comprises a microstructure or nanostructure, for example a honeycomb structure, which deforms depending on the temperature. Such a microstructure or nanostructure is configured to deform in a similar way to that of the first embodiment.

As a result, depending on the deformation of the microstructure, or nanostructure, the rod 13 is moved in a similar way to that of the first embodiment.

The flexible blades described in the various embodiments of the balance spring can be continuous flexible blades, as is typically the case in the figures, or blades with rigid sections and flexible collars connecting the sections.

The invention further relates to a regulating member, not shown in the figures, in particular for a horological movement. The regulating member comprises, for example, an oscillating weight and a balance spring as described above. The oscillating weight is, for example, an annular balance. The oscillating weight is joined to the balance spring so that it is integral with the support.

1. A balance spring for a horological regulating member, the balance spring (1) comprising:
a flexible strip (2) wound about itself in several turns, the strip (2) having a predefined stiffness;
adjusting means for adjusting the stiffness of the flexible strip; and
actuation means (10) for actuating the adjustment means depending on the ambient temperature.

2. The balance spring according to claim 1, wherein the actuation means (10) comprise an element (11) which can be deformed depending on the temperature.

3. The balance spring according to claim 2, wherein the deformable element (11) comprises a temperature-sensitive material.

4. The balance spring according to claim 2, wherein the deformable element (11) comprises a bimetallic attachment.

5. The balance spring according to claim 2, wherein the deformable element (11) comprises a microstructure or nanostructure.

6. The balance spring according to claim 2, wherein the actuation means (10) comprise a support body (12) that can be moved by the deformable element (11), which moves it according to its deformation into a plurality of positions.

7. The balance spring according to claim 2, wherein the adjustment means comprise a flexible element (5) arranged in series with the strip (2), the flexible element (5) connecting one end (4, 9) of said strip (2) to a fixed support (53), so as to add additional stiffness following the strip (2), the flexible element (5) preferably having a stiffness greater than that of the strip (2).

8. The balance spring according to claim 7, wherein the adjustment means comprise prestressing means (6) for applying a variable force or torque to the flexible element (5), so as to vary the stiffness of the flexible element (5).

9. The balance spring according to claim 8, wherein the support body (12) is in contact with the prestressing means (6).

10. The balance spring according to claim 9, wherein the support body (11) comprises a rod (13) provided with a first end (17) mounted on the deformable element (12), and a second end (18) mounted on the prestressing means (6).

11. The balance spring according to claim 9, wherein the actuation means (10) comprise a fixed pin (21), which allows the rod (13) to form a lever.

12. The balance spring according to claim 7, wherein the flexible element (5) comprises two flexible parts (15, 16), each of which connects the strip (2) to the fixed support (53), the two flexible parts (15, 16) being arranged axially symmetrically relative to one another along an axis (A), the axis (A) preferably passing substantially through the centre (O) of the balance spring.

13. The balance spring according to claim 11, wherein the prestressing means (6) comprise two flexible levers (14, 26), each connected to a flexible part (15, 16).

14. The balance spring according to claim 13, wherein the two levers (14, 26) are connected to each other via a movable body (19).

15. A regulating member for a horological movement, the regulating member comprising an oscillating weight and the balance spring (1) according to claim 1.
